(19) United States
(12) Patent Application Publication
(10) Pub. No.: US 2006/0050981 A1
(43) Pub. Date: Mar. 9, 2006

(54) Technique for parallel MRI imaging (k-t grappa)

(76) Inventor: Feng Huang, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/221,334

(22) Filed: Sep. 6, 2005

Related U.S. Application Data
(60) Provisional application No. 60/607,121, filed on Sep. 3, 2004.

(51) Int. Cl. G06K 9/40

(52) U.S. Cl. 382/254

(57) ABSTRACT

The subject invention relates to a method for reconstructing a dynamic image series. Embodiments of the subject invention can be considered and/or referred to as a parallel imaging-prior-information imaging (parallel-prior) hybrid method. A specific embodiment can be referred to as k-t GRAPPA. The subject method can involve linear interpolation of data in k-t space. Linear interpolation of missing data in k-t space can exploit the correlation of the acquired data in both k-space and time. Several extra auto-calibration signal (ACS) lines can be acquired in each k-space scan and the correlation of the acquired data can be calculated based on the extra ACS lines. In an embodiment, ACS lines can be calculated based on other acquired data, such that values in an ACS line can be partially acquired and the unacquired values can be calculated and filled in based on the acquired values. In a preferred embodiment, no extra training data is used and no sensitivity map is used. In an embodiment, the extra ACS lines can be directly applied in the k-space to improve the image quality. Because the correlations exploited via the subject method are local and intrinsic, the subject method does not require that the sensitivity maps have no change during the acquisition. Advantageously, the subject method can be utilized when sensitivity maps change, preferably slowly, during the acquisition of the data.

### CROSS-REFERENCE TO RELATED APPLICATION

This application claims the benefit of U.S. Provisional Application Ser. No. 60/607,121, filed Sep. 3, 2004, which is hereby incorporated by reference herein in its entirety, including any figures, tables, or drawings.

### FIELD OF THE INVENTION

Embodiments of the invention incorporate correlations across k-space and time to generate magnetic resonance images.

### BACKGROUND OF THE INVENTION

Dynamic magnetic resonance imaging (MRI) captures an object in motion by acquiring a series of images at a high frame rate. Conceptually, the straightforward approach would be to acquire the full data for reconstructing each time frame separately. This requires the acquisition of each time frame to be short relative to the object motion in order to effectively obtain an instantaneous snapshot. However, this approach is limited by physical (e.g. gradient strength and slew rate) and physiological (e.g. nerve stimulation) constraints on the speed of data acquisition.

Over the years, a number of strategies have been proposed to further increase the acquisition rate by reducing the amount of acquired data by a given factor, referred to as the reduction factor hereafter. These strategies are able to reduce data acquisition without compromising image quality significantly because typical image series exhibit a high degree of spatiotemporal correlations, either by nature or by design. Therefore, there is a certain amount of redundancy within the data. Parallel imaging techniques and prior-information driven techniques are two independent sets of methods, which reduce MRI acquisition time through the reduction of the necessary amount of acquired k-space data, based on exploiting correlations across k-space and time, respectively. It is also possible to combine methods belonging to both of these sets of techniques to create new hybrid methods.

Parallel imaging techniques using multiple coils have become increasingly important since the late 1980s due to higher signal to noise ratios (compared to volume coils or large surface coils) and reduced MRI acquisition time. Some techniques require coil sensitivity maps, like sensitivity encoding (SENSE) (Pruessmann K. P., Weiger M., Scheidegger M. B., Boesiger P. SENSE: Sensitivity encoding for fast MRI. Magn Reson Med 1999;42:p 952-962), sub-encoding (Ra J. B., Rim C. Y. Fast imaging using subencoding data sets from multiple detectors. Magn Reson Med 1993;30:p 142-145), and simultaneous acquisition of spatial harmonics (SMASH) (Sodickson D. K., Manning W. J. Simultaneous acquisition of spatial harmonics (SMASH): ultra-fast imaging with radiofrequency coil arrays. Magn Reson Med 1997;38:p 591-603). SENSE provides an optimized reconstruction whenever a perfectly accurate coil sensitivity map can be obtained. However, there are some cases where the acquired sensitivity maps contain significant errors. For example, patient motion, including respiratory motion, can lead to substantial errors in acquired sensitivity maps, in particular at the coil edges where the coil sensitivity changes rapidly. Any errors contained in these maps propagate into the final image during SENSE reconstruction, and may also result in decreased signal-to-noise ratios. In such cases, methods utilizing interpolation of k-space data without the use of sensitivity maps can be a better choice.

VD-AUTO-SMASH (Heidemann R. M., Griswold M. A., Haase A., Jakob P. M. VD-AUTO-SMASH imaging. Magn Reson Med 2001;45:p 1066-1074), Generalized Auto calibrating Partially Parallel Acquisitions (GRAPPA) (Griswold M. A., Jakob P. M., Heidemann R. M., Mathias Nittka, Jellus V., Wang J., Kiefer B., Haase A. Generalized Autocalibrating Partially Parallel Acquisitions (GRAPPA)). Magnetic Resonance in Medicine 2002;47:p 1202-1210), and linear interpolation in k-space(LIKE) (Huang F., Cheng H., Duensing G. R., Akao J., Rubin A. Linear Interpolation in k-space. Intl Soc Mag Reson Med 12 2004; KYOTO. p 2139) are examples of such methods involving interpolation in k-space without using sensitivity maps. Both VD-AUTO-SMASH and GRAPPA use weighted linear combinations and extra k-space lines to interpolate missing k-space data. The extra lines are known as auto-calibration signal lines (ACS lines) and are used to generate the weights used in the linear combinations. VD-AUTO-SMASH interpolates the composite k-space. GRAPPA interpolates the k-space of individual coils. Drawbacks of VD-AUTO-SMASH are discussed in detail in Griswold M. A., Jakob P. M., Heidemann R. M., Mathias Nittka, Jellus V., Wang J., Kiefer B., Haase A. Generalized Autocalibrating Partially Parallel Acquisitions (GRAPPA). GRAPPA exploits correlation in k-space, but does not exploit correlation in the time direction.

Prior-information driven techniques are based on the idea that one should be able to acquire fewer data points given some degree of prior information about the object being imaged, such as similarity for dynamic images. Prior-information driven methods include, for example, key hole (Suga M., Matsuda T., Komori M., Minato K., Takahashi T. Keyhole Method for High-Speed Human Cardiac Cine MR Imaging. J Magn Reson Imag 1999;10:p 778-783), Broad-use Linear Acquisition Speed-up technique (BLAST) (Tsao J., Behnia B., Webb A. G. Unifying Linear Prior-Information-Driven Methods for Accelerated Image Acquisition. Magn Reson Med 2001;46:p 652-660), UNaliasing by Fourier-encoding the Overlaps using the temporaL Dimension (UNFOLD) (Madore B., Glover G. H., Pelc N. J. UNaliasing by Fourier-encoding the Overlaps using the temporaL Dimension (UNFOLD), applied to cardiac imaging and fMRI. Magn Reson Med 1999;42:p 813-828), and reconstruction with prior information for dynamic MRI (Huang F., Cheng H., Duensing G. R., Akao J., Rubin A. Reconstruction with Prior Information for Dynamic MRI. Intl Soc Mag Reson Med 12 2004; KYOTO, Japan. p 2680). These methods are based on exploiting temporal correlations of the data, but do not exploit correlations between multi-channel data.

Although parallel imaging techniques and prior-information driven imaging techniques form two distinct sets of methods for speeding up data acquisition by reducing the average amount of necessary k-space data needed per-coil, methods from both these sets may be combined to produce hybrid techniques. In one such combination, SENSE makes use of the key hole method (Z. Liang A. S., J. X. Ji, J. Ma, F. Boada. Parallel Generalized Series Imaging. ISMRM 11th Scientific Meeting & Exhibition ISMRM 2003; Toronto. p 2341) by using it to generate an approximate reconstruction image from which is derived a more accurate sensitivity map, then this sensitivity map and a generalized SENSE method is used to produce an improved reconstruction. This technique is accurate, but the computational complexity is considerable due to the need to minimize the large matrix system required by this method. Another combination, k-t SENSE (Tsao J., Boesiger P., Pruessmann K. P. k-t BLAST and k-t SENSE: dynamic MRI with high frame rate exploiting spatiotemporal correlations. Magn Reson Med 2003;50(5):p 1031-1042), actually on x-f space, still needs the information of sensitivity maps and requires a set of pre-scans as training data. Another method, parallel imaging with prior information for dynamic image (Huang F., Akao J., Rubin A., Duensing R. Parallel Imaging with Prior Information for Dynamic MRI. International Symposium on Biomedical Imaging 2004; Arlington, Va. p 217-220) is useful when the frames of a static region remains very similar and needs prior information regarding the location of the static region.

### BRIEF DESCRIPTION OF THE DRAWINGS

FIG. 1 shows schematically an embodiment of a k-t GRAPPA algorithm in accordance to the present invention.

FIGS. 2A-2L show oblique cardiac images, where FIGS. 2A and 2E show reference images for frames 1 and 10, respectively; FIGS. 2B and 2F show reconstructed images of frames 1 and 10, respectively, reconstructed by GRAPPA, with a width of 31 ACS lines; FIGS. 2C and 2G show images of frames 1 and 10, respectively, reconstructed by sliding GRAPPA, with a width of 31 ACS lines; FIGS. 2D and 2H show images of frames 1 and 10, respectively, reconstructed by an embodiment of k-t GRAPPA in accordance with the subject invention, with a width of 31 ACS lines; FIGS. 2I and 2K show images of frames 1 and 10, respectively, reconstructed by an embodiment of k-t GRAPPA in accordance with the subject invention with a width of 6 ACS lines; and FIGS. 2J and 2L show the difference between the images of FIGS. 2I and 2K and the reference images, respectively, with a width of 6 ACS lines and having the same scale [0 2].

FIGS. 3A-3L show sagittal cardiac images, where FIGS. 3A and 3E show reference images for frames 1 and 10, respectively; FIGS. 3B and 3F show an image of frames 1 and 10, respectively, reconstructed by an embodiment of GRAPPA in accordance with the subject invention with a width of 31 ACS lines; FIGS. 3C and 3G show an image of frames 1 and 10, respectively, reconstructed by sliding GRAPPA with a width of 31 ACS lines; FIGS. 3D and 3H show an image of frames 1 and 10, respectively, reconstructed by k-t GRAPPA with a width of 31 ACS lines; FIGS. 3I and 3K show an image of frames 1 and 10, respectively, reconstructed by an embodiment of k-t GRAPPA in accordance with the subject invention with a width of 6 ACS lines; and FIGS. 3J and 3L show the difference between the images of FIGS. 2I and 2K and the corresponding reference images, respectively, with a width of 6 ACS lines and having the same scale [0 1].

FIGS. 4A-4D show functional MRI images, where FIG. 4A shows the mean (along time) relative error of each slice; FIG. 4B shows the relative error of slice 15; FIG. 4C shows the T-test map of slice 10 with original images; and FIG. 4D shows the T-test map of slice 10 with reconstructed images by an embodiment of k-t GRAPPA in accordance with the subject invention (reduction factor 3, 31 ACS lines).

FIGS. 5A and 5B illustrate an algorithm for acquiring k-t space data for a specific embodiment of the subject invention, where FIG. 5B shows a blow-up of a section of FIG. 5A.

FIG. 6 shows schematically an embodiment of a k-t GRAPPA algorithm, without fully acquired ACS lines, for a reduction factor of 4, where the solid lines are acquired for fill-in and the dotted lines are to be approximated, in accordance with an embodiment of the invention.

FIG. 7 shows schematically an embodiment of a k-t GRAPPA algorithm, without fully acquired ACS lines, for a reduction factor of 2, where the solid lines are acquired for fill-in and the dotted lines are to be approximated, in accordance with an embodiment of the invention.

FIGS. 8A-8E show images produced using an embodiment of the invention for a reduction factor of 2, corresponding to 5 frames, 10 frames, 15 frames, 20 frames, and 25 frames, respectively.

FIGS. 8F-8J show images produced using an embodiment of the invention for a reduction factor of 3, corresponding to 5 frames, 10 frames, 15 frames, 20 frames, and 25 frames, respectively.

FIGS. 8K-8O show images produced using an embodiment of the invention for a reduction factor of 4, corresponding to 5 frames, 10 frames, 15 frames, 20 frames, and 25 frames, respectively.

FIGS. 9A-9E show a zoomed portion of the images of FIGS. 8A-8E, respectively.

FIGS. 9F-9J show a zoomed portion of the images of FIGS. 8F-8J, respectively.

FIGS. 9K-9O show a zoomed portion of the images of FIGS. 8K-8O, respectively.

FIG. 10A shows a data acquisition algorithm having a reduction factor of 6.

FIG. 10B shows a k-t space grid in accordance with the algorithm of FIG. 10A after filling in adjacent k positions with respect to FIG. 10A.

FIGS. 11A-11C show data acquired over three time frames where the black dots indicate a line of acquired data in the frequency encode direction for certain combinations of phase encode k_{y} positions and partition direction k_{z} positions.

FIG. 11D shows a partially filled-in k-space time frame after interpolation with respect to two-dimensional k-space data shown in FIGS. 11A-11C.

FIGS. 12A-12C show data acquired over three time frames where the black dots indicate a line of acquired data in the frequency encode direction for certain combinations of phase encode k_{y} positions and partition direction k_{z} positions.

FIG. 12D shows a partially filled-in k-space time frame after interpolation with respect to two-dimensional k-space data shown in FIGS. 12A-12C.

FIG. 13A shows the same data acquisition algorithm as shown in FIG. 10A. Referring to FIG. 13B, in an embodiment, the k_{y} position midway between two acquired k_{y} position in a time frame can be interpolated using the acquired data.

### DETAILED DESCRIPTION OF THE INVENTION

The subject invention relates to a method for reconstructing a dynamic image series. Embodiments of the subject invention can be considered and/or referred to as a parallel imaging-prior-information imaging (parallel-prior) hybrid method. A specific embodiment can be referred to as k-t GRAPPA. The subject method can involve linear interpolation of data in k-t space.

Linear interpolation of missing data in k-t space can exploit the correlation of the acquired data in both k-space and time. Several extra auto-calibration signal (ACS) lines can be acquired in each k-space scan and the correlation of the acquired data can be calculated based on the extra ACS lines. In an embodiment, ACS lines can be calculated based on other acquired data, such that values in an ACS line can be partially acquired and the unacquired values can be calculated and filled in based on the acquired values. In a preferred embodiment, no extra training data is used and no sensitivity map is used. In an embodiment, the extra ACS lines can be directly applied in the k-space to improve the image quality. Because the correlations exploited via the subject method are local and intrinsic, the subject method does not require that the sensitivity maps have no change during the acquisition. Advantageously, the subject method can be utilized when sensitivity maps change, preferably slowly, during the acquisition of the data.

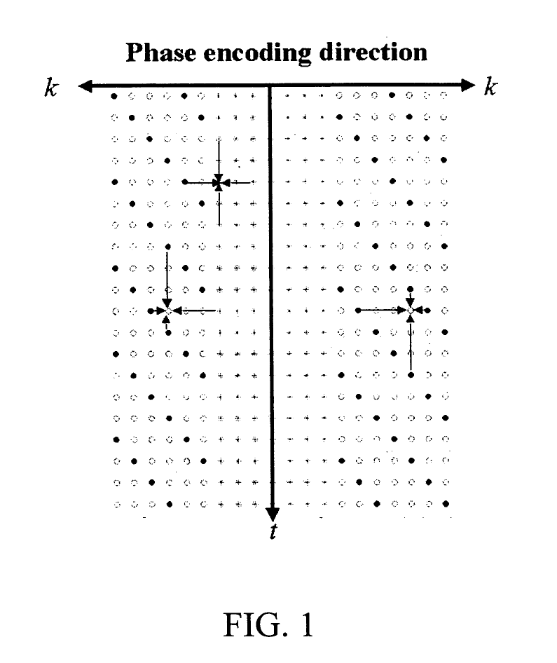

In a specific embodiment, dynamic MRI can acquire the raw data in k-space via a plurality of scans occurring during a corresponding plurality of time frames. The data can be acquired via scans over the phase encode direction, such that each scan includes subscans of the frequency encode direction for each value of phase encode position to be scanned. The time of each frequency encode direction scan is short compared to the scan over the phase encoded direction such that each frequency encode direction scan can be associated with a point in time and in an approximate sense can be considered to have been taken at the point in time. Referring to FIG. 1, an entire row of data is illustrated to have been taken at a point of time, which can be referred to as a time frame on the vertical time axis, where the data acquired in the row is taken during a scan over the phase encode direction. During each scan, an array of k-space data points can be created in two dimensions of k-space, k_{y} and kₓ, where k_{y} is the phase encode direction and kₓ is the frequency encode direction. Because the time required to acquire the array of k-space data points during each k scan is short compared with the time frame for the scan over k_{y} positions, the data array can be shown on the graph to have been acquired at a point in time, which can represent a time frame.

In an embodiment, data in k-space can be acquired via a plurality of scans initiated at and/or associated with a corresponding plurality of time frames, t₁, t₂, . . . , tᵥ, where tₛ₊₁−tₛ=Δt, for s=1, 2, . . . , v-1, such that for each time frame tₛ, the k-space can be sampled in a Cartesian manner to produce a k-t sampling pattern of acquired data. The raw data can be equivalently viewed as being acquired in a higher dimensional k-t space. The arrangement of these discrete samples in k-t space can be referred to as the k-t sampling pattern.

An embodiment of the subject method can be referred to as k-t generalized autocalibrating partially parallel acquisitions (k-t GRAPPA). FIG. 1 shows a one channel, two-dimensional plot of an embodiment of a k-t GRAPPA algorithm in accordance with the subject invention. It shows an embodiment of a sampling pattern algorithm in accordance with the subject invention for a reduction factor of 4. The frequency-encoding direction, oriented perpendicular to the page is omitted for simplicity. The horizontal ‘k” axis, lying in the plane of FIG. 1, refers to the index of the phase-encode line and can be considered k_{y}. The rows represent the phase encoding direction such that each position of a row is a different phase encode line for a certain time frame, where k varies from −π (at the far left column) to 0 (center column with dark line as t-axis) to π (far right column). Each position in a column represents a certain k phase value for each scan. The black dots represent acquired data, the open circles represent missing data, and the stars represent fully acquired central bands of ACS lines.

In an embodiment, the black dots can represent a fully acquired line of kₓ data, or frequency-encode data. There can be many data points taken for various values of kₓ frequency encode) such that each black dot on the graph in FIG. 1 can actually represent these many data points for a certain value of k_{y} (phase-encode) and many corresponding values of kₓ (frequency-encode). The acquired data can be acquired based on an algorithm as to form an equally spaced, time interleaved plot. In this way, for a value of k_{y} corresponding to a black dot (far left in FIG. 1) for t₁, for all values of kₓ, can be obtained and then all the data for the next value of k_{y} corresponding to the next black dot to the right for t₁, for all values of kₓ can be obtained. Data collection can continue for successive values of k_{y} corresponding to black dots, for t₁, until all data has been collected for the k_{y} values corresponding to black dots, for t₁. The same data collection process can then be accomplished for the k_{y} values corresponding to black dots, for t₂, and for t₃, t₄, . . . , tᵥ. Although FIG. 1 shows the _{y} value of acquired data shifting one increment of k_{y}, Δk_{y}, for adjacent scans, other protocols can be implemented. For example, for the case of a reduction factor of 4, the k_{y} value can shift two increments of k_{y}, 2Δk_{y}, to the right from t₃ to t₂, shift Δk_{y} to the left from t₂ to t₃, shift Δk_{y} to the left from t₃ to t₄, shift 3Δk_{y} to the left from t₄ to t₅, and then repeat the sequence for

$${t}_{4 n + 1} ( n = 1 , … , \frac{v - 1}{4} ) .$$

By repeating the pattern for

$${t}_{4 n + 1} ( n = 1 , … , \frac{v - 1}{4} )$$

the time difference between two time adjacent acquired data values for a certain combination of k_{y} and kₓ can be a constant for all such acquired data values having time adjacent acquired data values, when the data acquisition algorithm is the same for tₙ and tₙ+r, where r is the reduction factor.

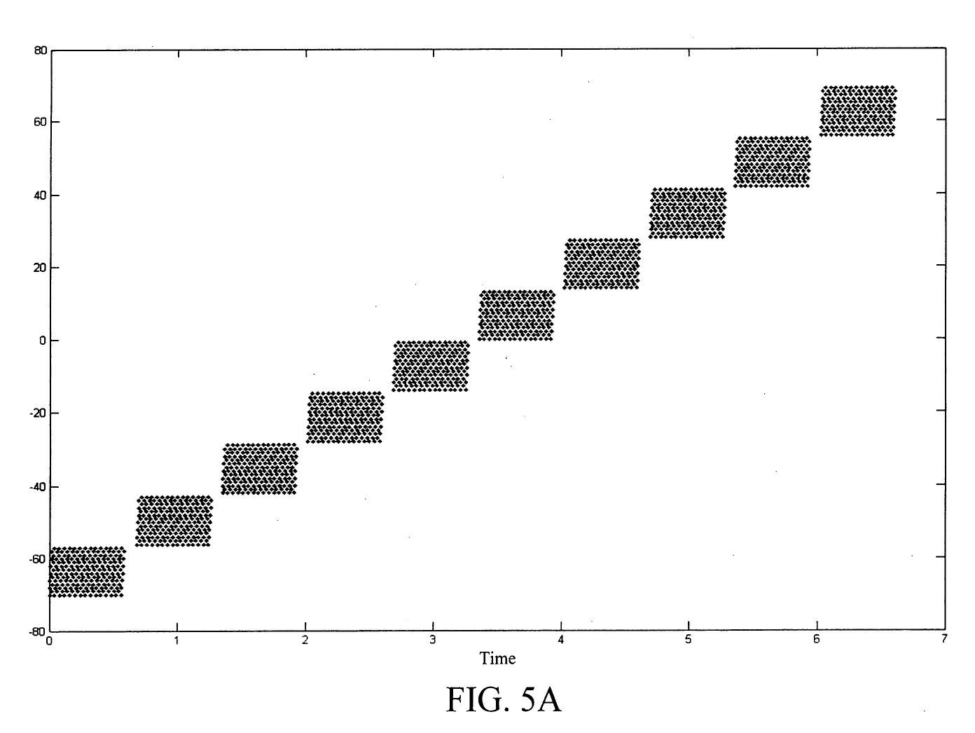

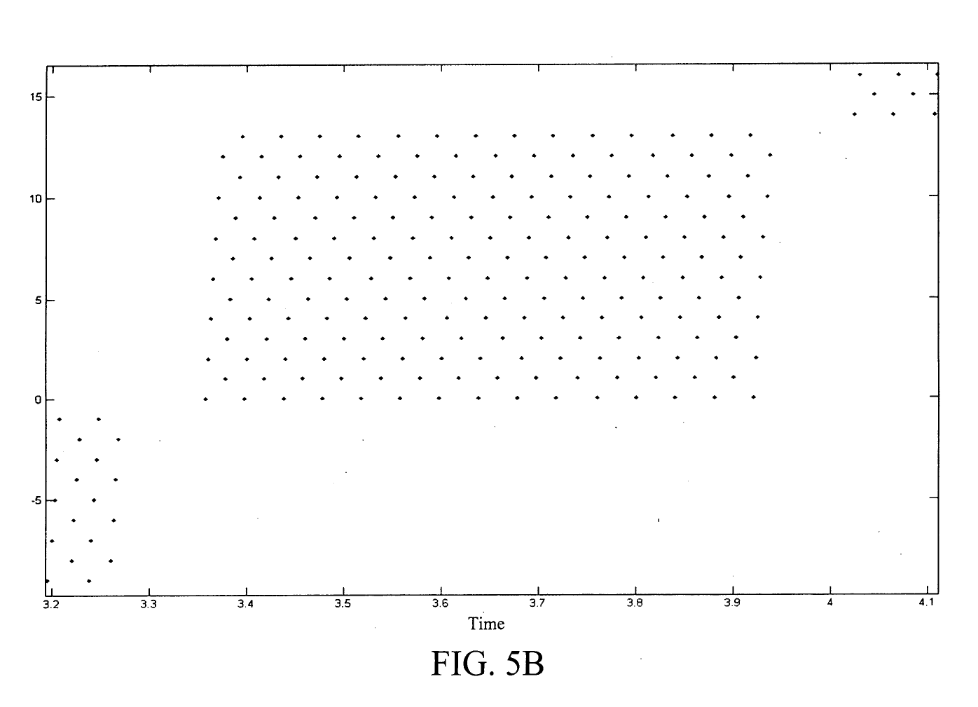

The subject method can also involve other algorithms for acquiring the k-t space data. Referring to FIG. 5A, an acquisition algorithm utilized in a specific embodiment of the subject invention for imaging the heart is shown. The algorithm shown in FIG. 5A breaks the k_{y} axis into 10 blocks, each having 14 values for a total of 140 k_{y} values. If desired, the outer 6 values on the two outer blocks can be ignored such that 128 values are utilized. FIG. 5B shows a blow-up of a time segment from FIG. 5A where data with k_{y} values around k_{y}=0 are measured. Each block in FIG. 5A (one complete block is shown in FIG. 5B) is taken during one heart beat of the patient and includes 29 columns of data, each column including data taken at 7 values of k_{y}. Every other column in each block shifts one Δk_{y} with respect to the k_{y} value of the acquired data in the previous column. The algorithm shown in FIGS. 5A and 5B correspond to a reduction factor of 2. Referring to FIG. 5B, the first column of data is acquired for k_{y}=2nΔk_{y} (n=0, 1, 2, . . . , 6) and the second column of data is acquired for k_{y}=(2n+1) Δk_{y} (n=0, 1, 2, . . . , 6). The remaining odd numbered columns acquired data for the same k_{y} values as the first column and the remaining even numbered columns acquire data for the same k_{y} values as the second column. The data from the first column from each block is, after interpolating to find the missing data, then combined to generate a first image and the data from the second column from each block is, after interpolating to fill in the missing data, combined to generate a second image. Likewise, the remaining n^{th} column from each block is, after filling in the missing data, combined to generate an additional image, to yield a total of 29 images. For these cardiac images each block is triggered to be measured based on the patient's heart beating such that each block is measured at the same time delay following a certain point in the cardiac cycle. In this way, the n^{th} column of each block is measured at the same point in the patient's cardiac cycle, as in the n^{th} column of each of the other block.

Continuing to refer to the embodiment illustrated in FIGS. 5A and 5B, the interpolation step of the subject invention for filling in the missing data can involve treating the data corresponding to k_{y} values in separate blocks, and from the same column, as adjacent acquired data. In this way, with respect to equation (1), to be discussed later in the application, the data from the first columns of each block are treated as acquired at the same point in time, or time frame, for purposes of interpolating the missing data, as are the data from the n^{th} column of each block.

In an embodiment, the acquired k-space data can be time interleaved similar to the sampling pattern described in UNFOLD (Madore B., Glover G. H., Pelc N. J. Unaliasing by Fourier-encoding the Overlaps using the temporaL Dimension (UNFOLD), applied to cardiac imaging and FMRI. Magn Reson Med 1999;42:p 813-828) and/or can be time interleaved similar to the sampling pattern described in TSENSE (Kellman P., Epstein F. H., McVeigh E. R. Adaptive Sensitivity Encoding Incorporating Temporal Filtering (TSENSE). Magn Reson Med 2001; 45:p 846-852).

In an embodiment, at each time point t, one or more ACS lines can also be acquired in addition to the regularly spaced phase-encode lines. In a preferred embodiment, because the center of k-space can have high energy, the ACS lines can be generally located at the center of k-space. In alternative embodiments, the ACS lines can be located at other positions in k-space. In a specific embodiment, for each k-space, there can be a fully acquired central band. Different sets of phase-encode lines can be acquired at successive time points. In further embodiments, ACS lines need not be acquired, such that, for example, acquired data from adjacent time points can be used for determining the weights to be used for interpolation.

Reconstruction of a dynamic image series can involve determining the object signals in k-t space from the discretely sampled data. In an embodiment, uncombined images can be generated for each coil in the array by applying multiple block wise reconstruction to generate the missing lines for each coil. Unlike conventional GRAPPA, the subject k-t GRAPPA method can utilize data from different time points in addition to data from the same time point and different k-value to interpolate the missing data. A variety of criteria for selection of data for use in interpolating missing data can be implemented. In addition, a different number of adjacent acquired data can be used for interpolation. In an embodiment, data from different time periods, but same k-value as the missing data can be used to interpolate the missing data. Additionally, data from the same time period as the missing data, but different k-value, can be used to interpolate the missing data. In a further embodiment, data from different time periods and different k-values than the missing data can be used to interpolate the missing data.

FIG. 1 illustrates, in the case of one channel, three examples for interpolation using acquired data from different time periods, but same k-value as the missing data and acquired data from same time period, but different k-value as the missing data. The data used to interpolate missing data are shown at the non-pointed end of the arrows. In this embodiment, the data at line k_{y} in time t, the data at line k_{y}-rΔk_{y} in time t, the data at line k_{y}-mΔk_{y} in time t-m, and the data at line k_{y}-mΔk_{y} in time t+r-m can be used to interpolate the data at a line k_{y}-mΔk_{y} in time t, where m is the offset from the normally acquired data and r is the reduction factor. Specifically, the data used to interpolate a missing data are actually the closest acquired neighbors on the same row and the same column in k-t space. For missing data near the edges in k-space or time, the interpolation can be accomplished without the information from acquired data on an absent k-space point or time frame.

In a further embodiment representing a multi-channel case, all channels can apply the same sampling pattern algorithm. For example, each channel of a multi-channel case can use the sampling pattern shown in FIG. 1. For each missing data, the adjacent data from all channels in the same adjacent position as shown in FIG. 1 can be utilized for interpolation. In an embodiment where the reduction factor is 4 and the number of channels is 4, 16 data (4 from each channel) can be utilized for interpolation.

In an embodiment utilizing multiple channels, data from multiple lines from all coils as well as adjacent time can be used to interpolate a missing line in a single coil. First, the described data is used to linearly fit acquired data points, such as data points from ACS lines. This linear fit can provide the weights to be used for interpolating missing data using closest acquired neighbor data points. Second, the weights can then be used to generate the missing lines from that coil. Third, once all of the lines are reconstructed for a particular coil, a Fourier transform can be used to generate the uncombined image for that coil. Once this process is repeated for each coil of the array, the full set of uncombined images can be obtained, which can then be combined using a normal sum-of-squares reconstruction. In general, the process of reconstructing data in coil j at a line k_{y}-mΔk_{y} in time t using a block wise reconstruction can be represented by:

$${S}_{j}^{t} ( {k}_{y} - m Δ {k}_{y} ) = {\sum }_{l = 1}^{L} ( {\sum }_{b = 0}^{{N}_{b} - 1} {n}_{b} ( j , l , m ) {S}_{l}^{t} ( {k}_{y} - b r Δ {k}_{y} ) + {\sum }_{v = t - m , t + r - m} {n}^{v} ( j , l , m ) {S}_{l}^{v} ( {k}_{y} - m Δ {k}_{y} ) ) \qquad [ 1 ]$$

where r represents the acceleration factor, also called the reduction factor. The first term in equation (1) is the data at the same time and different k_{y}, while the second term is the data at the same k_{y} and different time. The index j labels the coil and is set for each use of the equation (1). Referring to equation (1), n_{b} is the number of blocks used in the reconstruction, where a block is defined as a single acquired line and r-1 missing lines and L is the number of channels. In this embodiment, n_{b}(j,l,m) and n^{v}(j,l,m) can be generated by fitting the ACS lines and can represent the weights used in this now expanded linear combination. In this linear combination, the index l counts through the individual coils, the index b counts through the individual reconstruction blocks, and the index v counts through the adjacent frame (time) that acquired data at line k_{y}-mΔk_{y}. This process can be repeated for each coil in the array, resulting in L uncombined single coil images at each time t. The uncombined single coil images can then be lo combined using, for example a conventional sum-of-squares reconstruction. In an alternate embodiment the uncombined single coil images can be combined using any other optimal array combination.

The subject invention can choose data for interpolation from a variety of different positions and can select a variety of different numbers of adjacent acquired data for interpolation. In addition, ACS lines can be acquired at a variety of k_{y} locations. In certain embodiments, ACS lines need not be acquired. For example, by applying the sampling pattern algorithm described in TSENSE (Magn Reson Med 2001.: 45: p. 846-852) acquired data in the adjacent time scan be used for interpolation.

### EXAMPLE 1

A parallel-prior hybrid method of linear interpolation of data in k-t space in accordance with the subject invention was applied to cardiac MRI and functional MRI. The parallel-prior hybrid method of linear interpolation of data in k-t space, which can be referred to as k-t GRAPPA, was implemented in the MATLAB programming environment (MathWorks, Natick, Mass.) and run on a COMPAQ PC with a 2 GHz CPU and 1 Gb RAM. This embodiment of the subject invention (k-t GRAPPA), GRAPPA, and sliding block GRAPPA were all applied in each experiment. The experiment of cardiac MRI demonstrates that images reconstructed by k-t GRAPPA have less error than images reconstructed by conventional GRAPPA and images reconstructed by sliding block GRAPPA. The functional MRI experiment shows that k-t GRAPPA, even with only a single channel, can dramatically reduce acquisition time without loss of crucial information. To show the accuracy, the reconstructed image was compared with the reference image, which is generated by using full k-space. Let the phrase “intensity difference” refer to the difference in magnitudes between the reconstructed and reference images at each pixel. We can define the “relative error” as the magnitude of the “intensity difference” summed over every pixel in the image divided by the sum of the absolute values of each pixel in the reference image. For a reduction factor of 4 in Eq [1], missing data can be interpolated by weighted linear combination of 4 adjacent acquired data from each channel in k-t space. For missing data near the boundary in k-t space, not all 4 adjacent data are available. In this case, we only use the available ones. For example, for open data points near the edge of the k-t pattern, there may only be 3 adjacent acquired data.

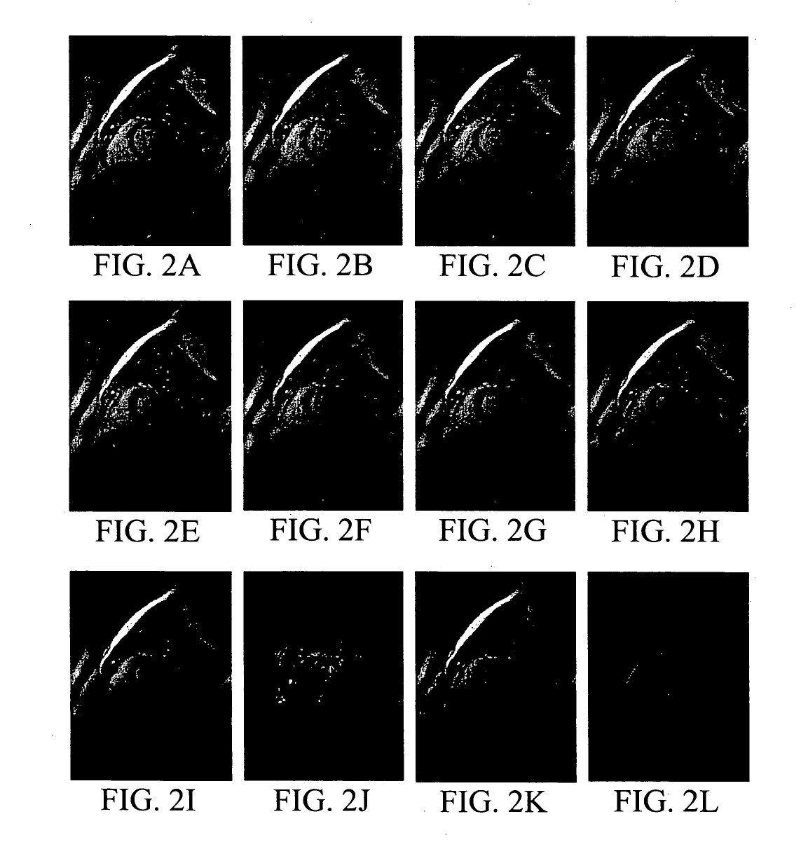

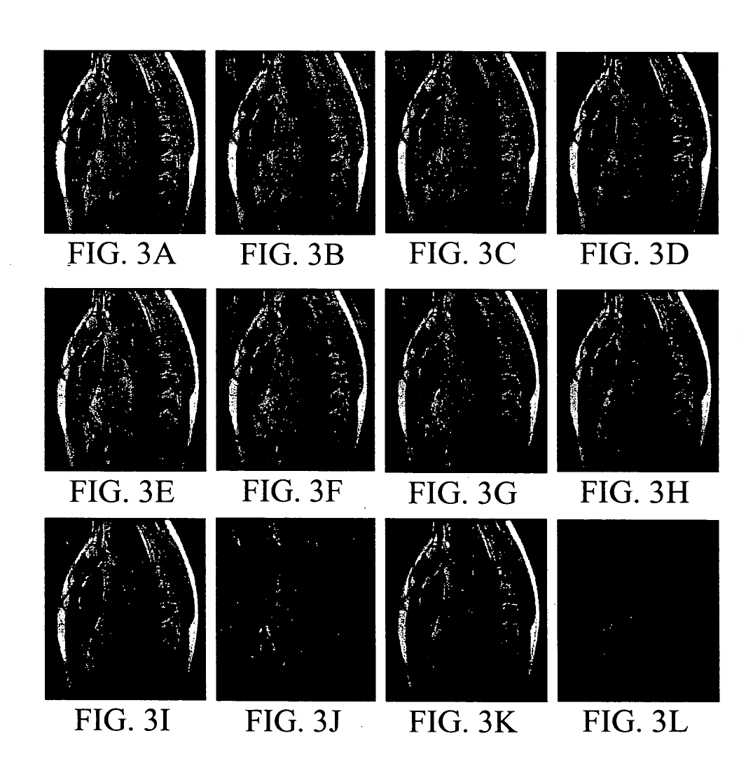

FIGS. 2A-2L show the results for oblique cardiac images and FIGS. 3A-3L show the results for sagittal cardiac images. Sagittal cardiac images were collected by a 1.5T GE system (FOV 280 mm, matrix 160×120, TR 4510 ms, TE 2204 ms, flip angle 45°, Slice thickness 6 mm, number of averages 2) through fast imaging employing steady-state acquisition (FIESTA) with a GE 4-channel cardiac coil. Breath-holds ranged from 10-20 seconds. There are 20 images per heartbeat.

To test an embodiment of k-t GRAPPA in accordance with the subject invention, the pseudo-sampling pattern such as in FIG. 1 was applied to generate the k-t space for reconstruction. The phase encoding direction is anterior-posterior. The reduction factor is 4. Different widths of the central ACS band were used. For comparison, GRAPPA and sliding block GRAPPA were then applied to the same k-space data at each time t. FIGS. 2A and 2E show reference images where the reference images are created based on a full set of acquired data with respect to the k-t space. Referring to FIGS. 2B and 2F, it can be seen that the images reconstructed by conventional GRAPPA have more artifacts and noise. However, referring to FIGS. 2D and 2H, the images reconstructed by the subject k-t GRAPPA method have no visible difference from the reference. FIGS. 2I-2L demonstrate that the subject k-t GRAPPA method can still generate accurate results even with few ACS lines, as only 6 ACS lines were acquired. Table 1 shows the comparison of relative errors between GRAPPA the subject and k-t GRAPPA method. It can be seen from Table 1 that an embodiment of the subject k-t GRAPPA method used in this example does not appear sensitive to the number of ACS lines and, hence, does not appear sensitive to an increase in the reduction factor. Even when conventional GRAPPA does not work, the subject k-t GRAPPA method can still generate very accurate results. Furthermore, the reconstruction time for the subject k-t GRAPPA method is shorter.

TABLE 1
Comparison of GRAPPA and k-t GRAPPA

| | | | Sliding block | |
|---|---|---|---|---|
| | | | GRAPPA | k-t |
| | | GRAPPA | (3 blocks) | GRAPPA |
| 31 ACS lines, true | Reconstruction time | 9.39 s | 20.48 s | 7.25 s |
| reduction factor 2.26 | Relative error | 6.67% | 6.35% | 3.20% |
| 21 ACS lines, true | Reconstruction time | 7.42 s | 16.04 s | 5.75 s |
| reduction factor 2.6 | Relative error | 13.51% | 10.8% | 3.48% |
| 11 ACS lines, true | Reconstruction time | Does | Does | 3.95 s |
| reduction factor 3.15 | Relative error | not work | not work | 3.80% |
| 6 ACS lines, true | Reconstruction time | Does | Does | 3.79 s |
| reduction factor 3.53 | Relative error | not work | not work | 4.11% |

FIGS. 3A-3L show the results for Sagittal cardiac images collected by the same 1.5T GE system (FOV 240 mm, matrix 192×256, TR 4530 ms, TE 1704 ms, flip angle 45°, Slice thickness 5 mm, number of averages 1). The phase encoding direction is anterior-posterior. The reduction factor is 4. The results show again that the subject k-t GRAPPA method can generate better results than GRAPPA. With 31 ACS lines, the mean relative error of the results by the subject k-t GRAPPA method was 2.47% and the reconstruction time was 14.29 s. However, the mean relative error of the results by GRAPPA and sliding block GRAPPA were 9.37%, 8.78% and the reconstruction time were 21.14 s and 48.23 s. When the number of ACS lines was reduced to 6, GRAPPA or sliding block GRAPPA did not work for reduction factor 4. But the embodiment of the subject k-t GRAPPA method can still consume 9.87 s to reconstruct images with mean relative error 3.47%. FIGS. 3I-3L show the result with only 6 ACS lines, and the true reduction factor is 3.62.

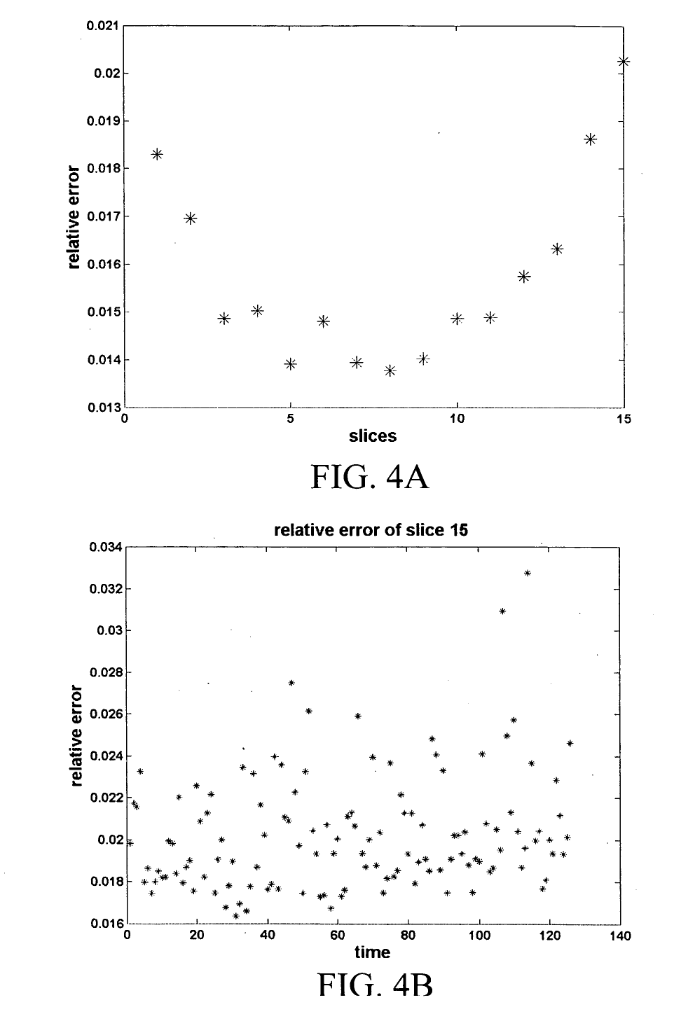

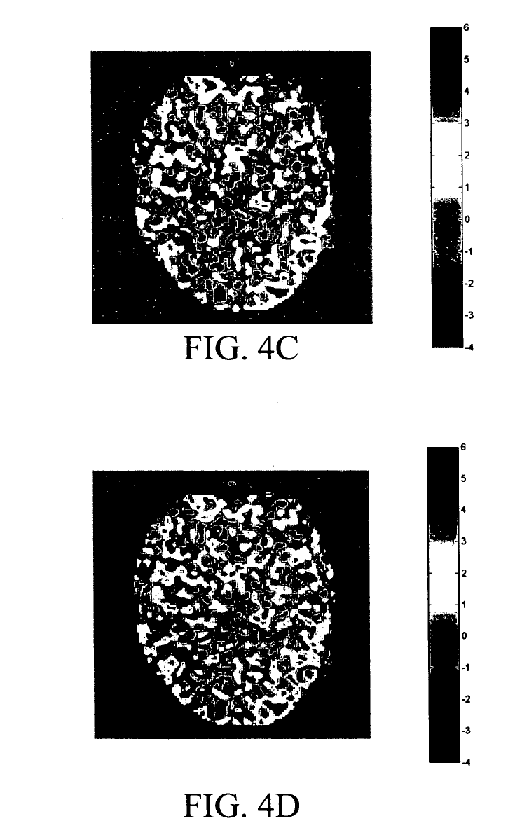

FIGS. 4A-4D show results for functional MRI. In this experiment, a set of data from BrainVoyager™ was used. The data is the magnitude of one channel. There are 15 slices, each slice has 126 frames (time), the matrix size is 128×128. An embodiment of the subject k-t GRAPPA method was applied to reconstruct the images with reduction factor of 3 with 31 ACS lines. FIG. 4A shows the mean (along time) relative error for each slice. The mean of relative error (time and slices) is 1.58%. FIG. 4B shows the relative error of slice 15. To show the influence of partial k-space to active area, T-test was made to both the reference images and the reconstructed images by the subject k-t GRAPPA method. FIGS. 4C and 4D show the T-test maps for the 10^{th} slice. This example shows that the subject k-t GRAPPA method can work for single channel data.

In embodiments of the invention, data can be acquired without fully acquiring ACS lines. In embodiments where ACS are not fully acquired, data from lines from adjacent time frames can be used to produce ACS lines. In specific embodiments, the ACS lines produced can form a complete set of ACS lines. In specific embodiments, the ACS lines can be partially acquired and then the unacquired data can be filled in. In an embodiment, the data from the nearest adjacent time frame can be used as ACS lines, and then data from the other 3 neighbors, can be used to approximate the data values. Using notation similar to equation [1], the formula for weight calculation for an embodiment can be represented by:

$${S}_{j}^{t - m} ( {k}_{y} - m Δ {k}_{y} ) = {\sum }_{l = 1}^{L} ( {\sum }_{b = 0}^{{N}_{b} - 1} {n}_{b} ( j , l , m ) {S}_{l}^{t} ( {k}_{y} - b r Δ {k}_{y} ) + {n}^{t + r - m} ( j , l , m ) {S}_{l}^{t + r - m} ( {k}_{y} - m Δ {k}_{y} ) )$$

$$( In case m \leq \frac{r}{2} )$$

$$or$$

$${S}_{j}^{t + r - m} ( {k}_{y} - m Δ {k}_{y} ) = {\sum }_{l = 1}^{L} ( {\sum }_{b = 0}^{{N}_{b} - 1} {n}_{b} ( j , l , m ) {S}_{l}^{t} ( {k}_{y} - b r Δ {k}_{y} ) + {n}^{t - m} ( j , l , m ) {S}_{l}^{t - m} ( {k}_{y} - m Δ {k}_{y} ) )$$

$$( In case m > \frac{r}{2} )$$

and the corresponding formula for interpolation can be represented by:

$${S}_{j}^{t} ( {k}_{y} - m Δ {k}_{y} ) = {\sum }_{l = 1}^{L} ( {\sum }_{b = 0}^{{N}_{b} - 1} {n}_{b} ( j , l , m ) {S}_{l}^{t} ( {k}_{y} - b r Δ {k}_{y} ) + {n}^{t + r - m} ( j , l , m ) {S}_{l}^{t + r - m} ( {k}_{y} - m Δ {k}_{y} ) )$$

$$( In case m \leq \frac{r}{2} )$$

$$or$$

$${S}_{j}^{t} ( {k}_{y} - m Δ {k}_{y} ) = {\sum }_{l = 1}^{L} ( {\sum }_{b = 0}^{{N}_{b} - 1} {n}_{b} ( j , l , m ) {S}_{l}^{t} ( {k}_{y} - b r Δ {k}_{y} ) + {n}^{t - m} ( j , l , m ) {S}_{l}^{t - m} ( {k}_{y} - m Δ {k}_{y} ) )$$

$$( In case m \leq \frac{r}{2} )$$

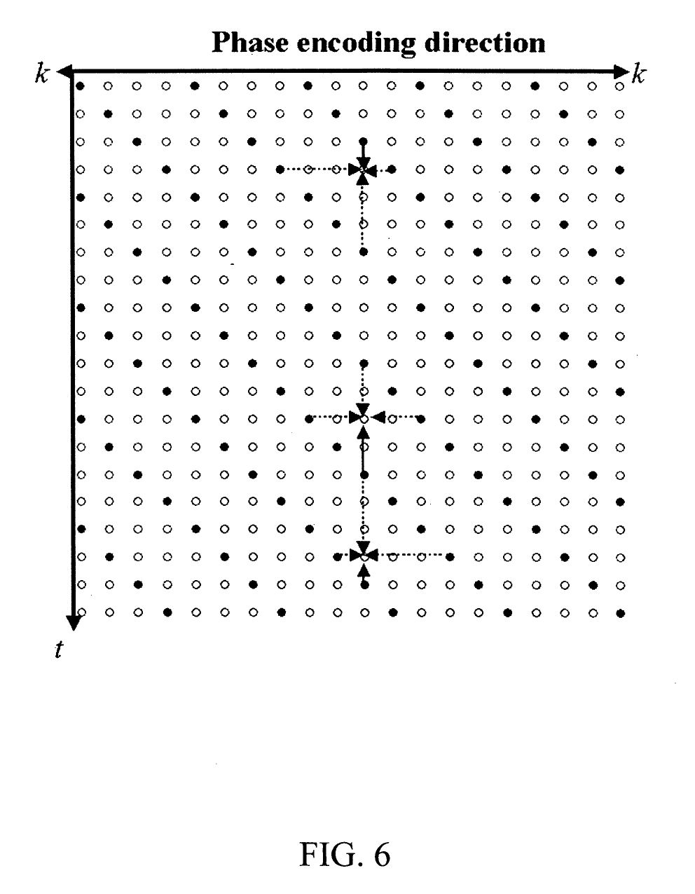

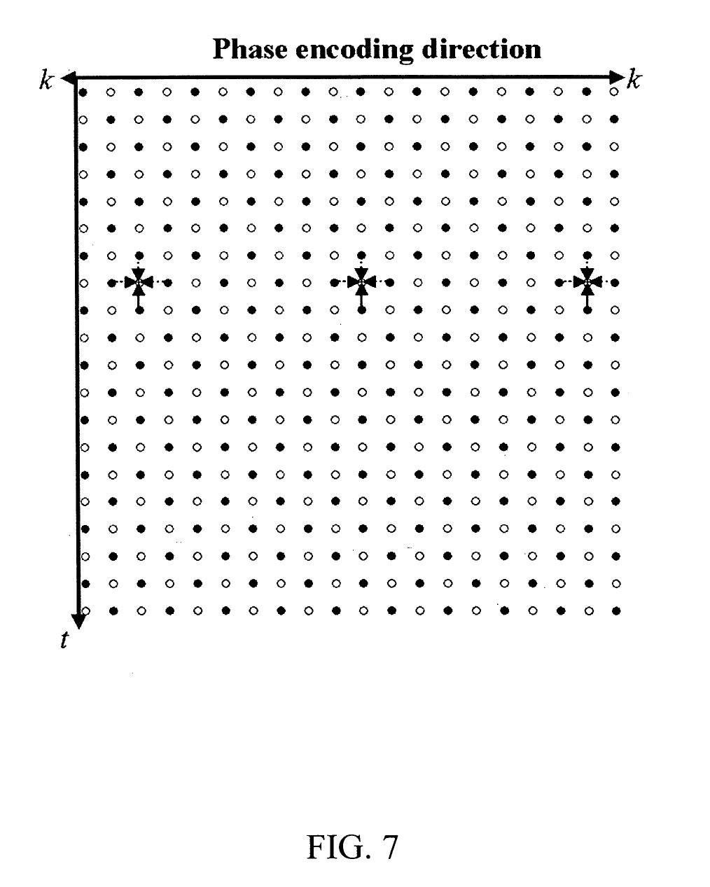

In a specific embodiment, the acquisition scheme and reconstruction method can be described with reference to FIGS. 6 and 7. FIG. 6 shows data acquired in accordance with an embodiment of the invention, with a reduction factor of 4. The black dots represent values of k in the phase encode direction for which data was acquired, such as for values of k in the frequency encode direction. The hollow circles represent values of k in the phase encode direction for which data was not acquired. In the embodiment shown in FIG. 6, ACS lines were not fully acquired. Rather, data was acquired in accordance with the data acquisition algorithm shown and ACS lines were created based on the acquired data. FIG. 6 shows three different interpolation cases with respect to the relative location of a hollow circle to black dots. The solid lines show fill-in and the dotted lines show approximation, in accordance with an embodiment of the invention. FIG. 2 shows data acquired in accordance with another embodiment of the invention, with a reduction factor of 2. The black dots, hollow circles, solid lines, and dotted lines have the same meaning as with respect to FIG. 6.

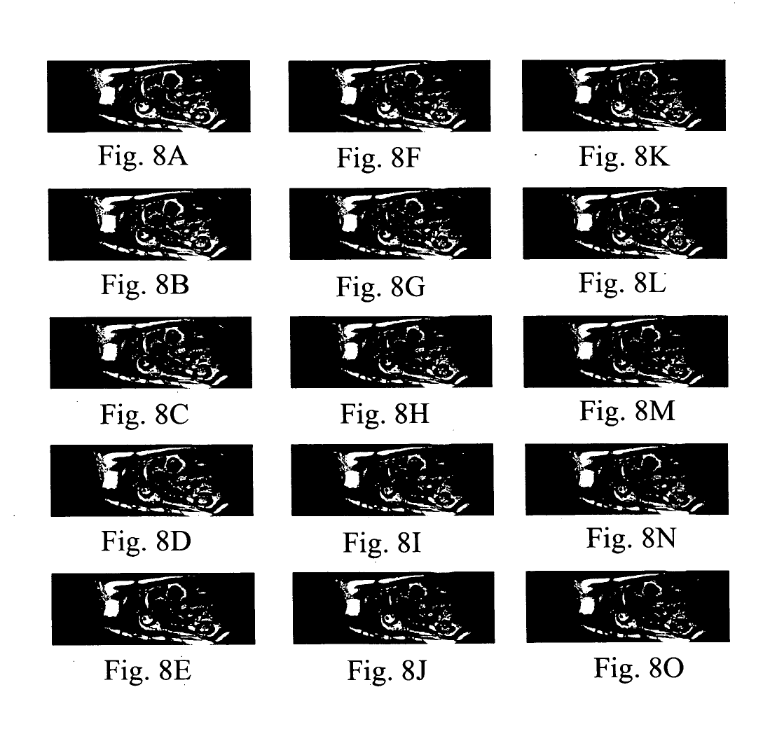

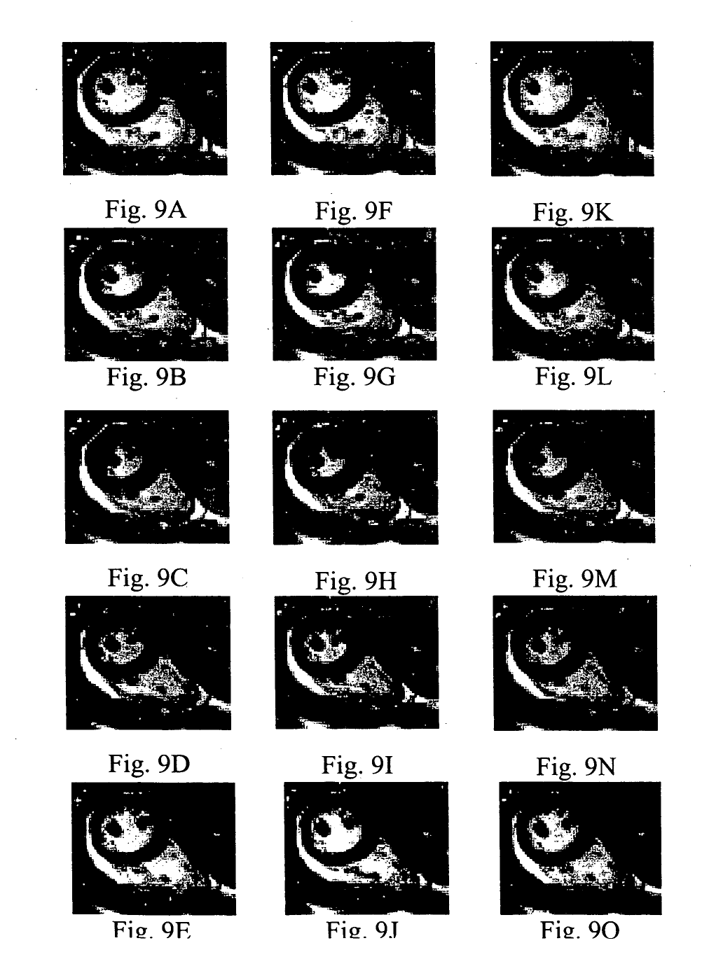

FIGS. 8A-8D show the results of imaging in accordance with an embodiment for which no extra ACS lines were acquired. FIGS. 8A-8E, FIGS. 8F-8J, and FIGS. 8K-8O, respectively, show images for data acquired with a reduction factor of 2, 3, and 4, and utilizing a data acquisition algorithm similar to the acquisition algorithm shown in FIGS. 6 and 7. FIGS. 8A, 8F, and 8K are based on 5 frames of data; FIGS. 8B, 8G, and 8L are based on 10 frames of data; FIGS. 8C, 8H, and 8M are based on 15 frames of data; FIGS. 8D, 8I, and 8N are based on 20 frames of data; and FIGS. 8E, 8J, and 8O are based on 25 frames of data. The phase encode direction is up-down. The Oblique cardiac images were collected by a SIEMENS Avanto system (FOV 340×255 mm, matrix 384×140, TR 20.02 ms, TE 1.43 ms, flip angle 46°, Slice thickness 6 mm, number of averages 1) through cine trueFISP with a SIEMENS Tim 12 channels cardiac coil. There were 29 images per heartbeat. FIGS. 9A-9O show zoomed portions of the images from 8A-8O, respectively. These results illustrate that the embodiment of the invention without fully acquired ACS lines can produce quality images.

Referring to FIG. 6, which shows a data acquisition algorithm with a reduction factor of 4, embodiments of the invention can involve the interpolation of a portion of the data corresponding to the phase encode positions for which data was not acquired. Referring to the top time frame of FIG. 6, the phase encode k values adjacent acquired data would be the 2^{nd}, 4^{th}, 6^{th}, 8^{th}, . . . positions, where the 1^{st}, 5^{th}, 9^{th}, . . . positions are acquired data. The non-acquired data can be filled in utilizing the data from the acquired phase encode k values. For example, the phase encode k values adjacent to acquired data in the same time frame can be filled in, such that another portion of the non-acquired phase encode k values remain non-acquired and non filled-in. This partially filled-in data and acquired data can then be used to produce images via one or more techniques known in the art, such as, but not limited to, TGRAPPA and TSENSE. In addition, once the phase encode k values adjacent phase encode k values are filled in, the remaining non-acquired phase encode k values can be further filled in by, for example, interpolation utilizing the data from the acquired phase encode k values and/or the data from the previously filled-in phase encode k values. Many different combinations can be used to fill in data.

Referring to FIG. 6, in an embodiment, a selected number of phase encode k values can be used to create ACS lines from the acquired data. In an embodiment, the ACS phase encode k values can be filled in with the average of the acquired data for each phase encode k value, such that for k_{y}, all time frames can be the average of the acquired k_{y}, data or all time frames having an unacquired k_{y}, can be filled with the average of the acquired k_{y}, data. In an embodiment, the number of ACS lines acquired, or filled in utilizing acquired data, can be equal to or large than the reduction factor plus 2, such that for a reduction factor of 4 in FIG. 6 the number of ACS lines filled in can be 6 or greater. In another embodiment, the number of ACS lines can be greater than or equal to the reduction factor plus 1. Although the ACS lines can be located at any position along the phase encode direction, in an embodiment the ACS lines are located near k_{y}=0.

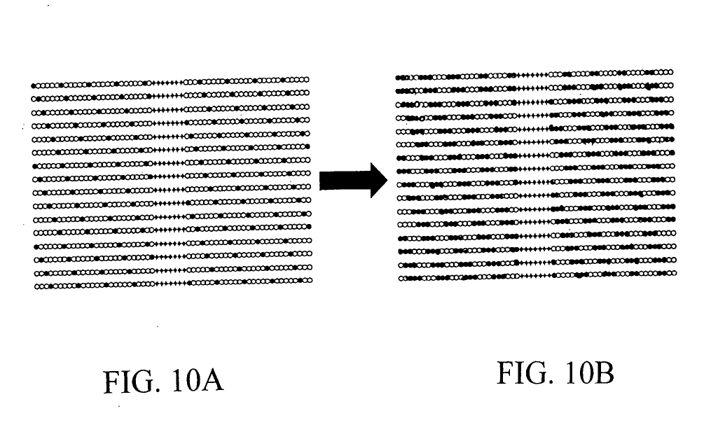

FIGS. 10-A-10B, 11A-11D, 12A-12D, and 13A-13B show additional data acquisition algorithms that can be implemented in accordance with the invention. FIG. 10A shows a data acquisition algorithm having a reduction factor of 6. There are 7 ACS lines (acquired or filled-in). In this embodiment the phase encode k_{y} values, or positions, adjacent acquired k_{y} positions are filled in utilizing interpolation of the acquired data. After this step half of the k_{y} positions will have data associated with the k_{y} position, as shown in FIG. 10B. This data can then be utilized to create images with techniques known in the art, such as, but not limited to TGRAPPA and TSENSE. In another embodiment, the k_{y} positions adjacent the newly filled-in k_{y} positions can be filled in by interpolating the adjacent filled-in data or the original acquired data. The last unfilled k_{y} positions can then be filled in by interpolation using the most recent filled-in data or some combination of acquired and/or filled-in data.

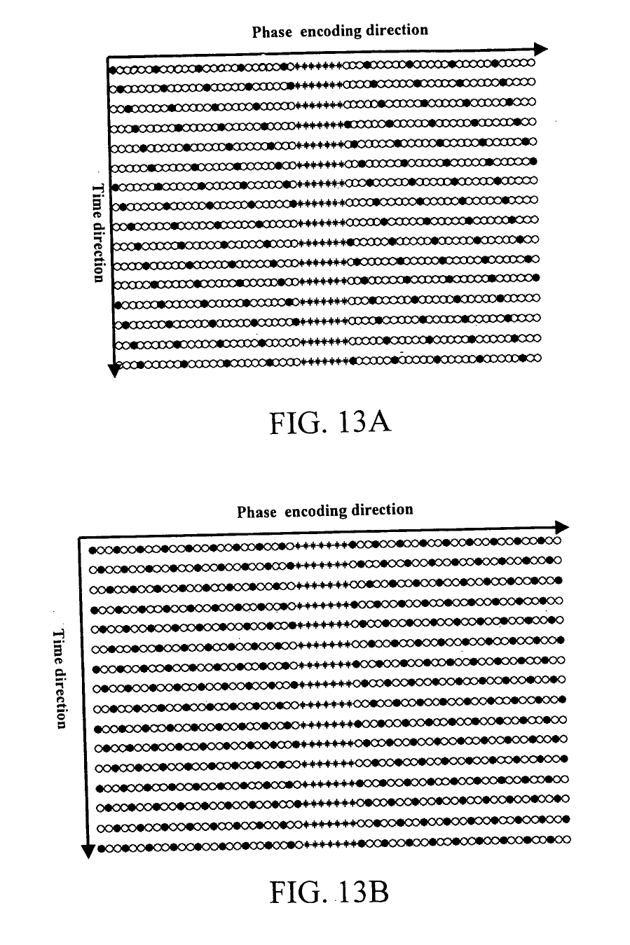

FIGS. 13A shows the same data acquisition algorithm as shown in FIG. 10A. Referring to FIG. 13B, in an embodiment, the k_{y} position midway between two acquired k_{y} position in a time frame can be interpolated using the acquired data. Again, this data can then be utilized to create images with techniques known in the art, such as, but not limited to TGRAPPA and TSENSE.

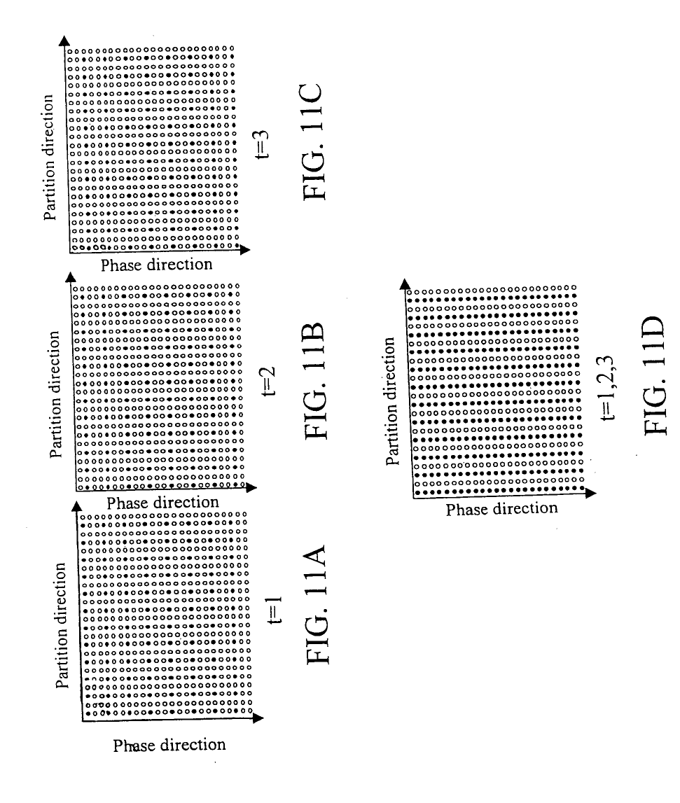

Embodiments of the invention also relate to data acquisition algorithms involving three-dimensional k-space acquisition having a reduction factor in the phase direction as well as in the partition direction. Referring to FIGS. 11A-11C, data can be acquired over 3 time frames where the black dots indicate a line of acquired data in the frequency encode direction for certain combinations of phase encode k_{y} positions and partition direction k_{z} positions. The reduction factor can be considered to be 6 (3×2), where the reduction is 3 in the phase direction and 2 in the partition direction. FIG. 11D shows a partially filled-in k-space time frame after interpolation in an analogous manner described above with respect to two-dimensional k-space data. In this embodiment the data for a phase encode k position and partition k position combination (k_{y}, k_{z}) can be filled in utilizing data from time frames having adjacent k_{y}, k_{z} position acquired data and adjacent acquired data from the k_{y} position of the same time frame.

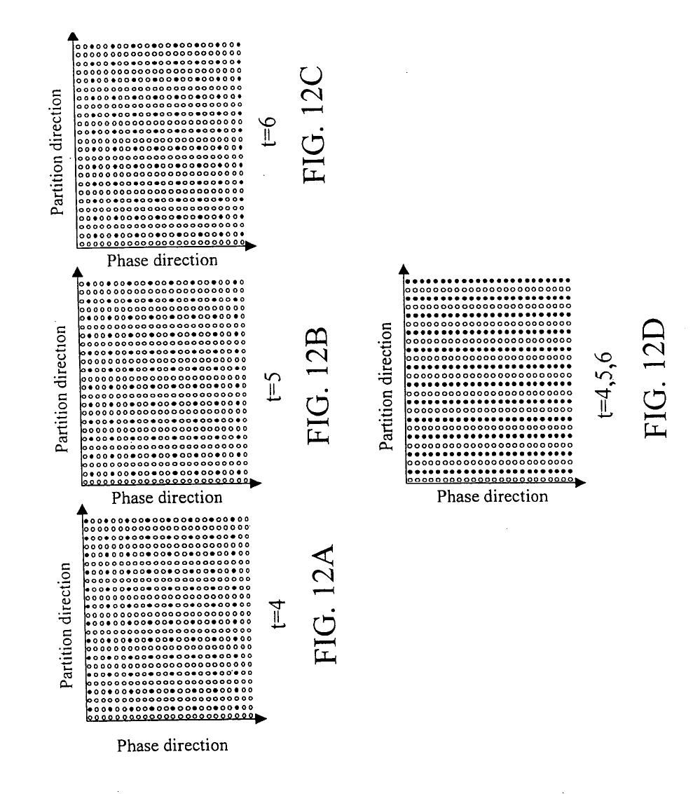

FIGS. 12A-12C show data acquired for the remaining time frames (t=4, t=5, t=6) for the 2×3 block associated with the data acquisition algorithm shown in FIGS. 11A-11C and 12A-12C. FIG. 12D shows a partially filled-in k-space time frame after interpolation of data in an analogous manner described above with respect to two-dimensional k-space data. In this embodiment the data for a phase encode k position and partition k position combination (k_{y}, k_{z}) can be filled in utilizing data from time frames having adjacent k_{y}, k_{z} position acquired data and adjacent acquired data from the k_{y} position of the same time frame. In a specific embodiment, with respect to FIGS. 11D and 12D, adjacent acquired data from the k_{z} position of the same time frame can also be utilized during fill in.

The data from FIGS. 11D and 12D can be used to produce images using known techniques such as, but not limited to, TSENSE and TGRAPPA. The use of the data of FIG. 11D and/or FIG. 12D can improve temporal resolution, but may lower SNR. Further interpolation to achieve a full set of data can give a higher SNR, but may lower temporal resolution. The use of the data acquisition algorithm of FIGS. 11A-11C and FIGS. 12A-12C can be used for contrast enhanced coronary imaging.

In a specific embodiment where ACS lines are not acquired, the weighted average k-space can be used as ACS lines.

As discussed above, embodiments of the invention involve interpolating to fill in a portion of the missing lines and the applying of other methods to further fill in other missing lines. These embodiments can have improved temporal resolution.

Although a Cartesian grid has been used for ease of presentation, embodiments of the invention pertain to other k-space data coordinate systems, such as, but not limited to, polar and pseudopolar.

All patents, patent applications, provisional applications, and publications referred to or cited herein are incorporated by reference in their entirety, including all figures and tables, to the extent they are not inconsistent with the explicit teachings of this specification. Sample and embodiments described herein are for illustrative purposes only and that various modifications or changes in light thereof will be suggested to persons skilled in the art and are to be included within the spirit and purview of this application and the scope of the appended claims.

We claim:

1. A method for reconstructing an image, comprising:
conducting a plurality of scans to acquire k-space data at discrete k-points on a k-space grid, wherein the plurality of scans correspond to a corresponding plurality of time frames, t₁, t₂, . . . , and tᵥ, for each time frame, t₁, t₂, . . . , and tᵥ, the k-space data acquired during the corresponding time frame form a Cartesian grid in two dimensions of k-space, k_{y} and kₓ, where k_{y} is the phase encode direction and kₓ is the frequency encode direction,
wherein the Cartesian grid is centered at k_{y}=0, wherein the Cartesian grid expands on each side of k_{y}=0 on the k_{y}-axis, wherein the phase difference between adjacent k_{y}-points, Δk_{y}, are equally spaced such that
$$Δ {k}_{y} = \frac{π}{n} ,$$
where n is the index number of the highest indexed k_{y}-point on the k_{y}-axis,
wherein the arrangement of the k-space data for the plurality of scans corresponding to the corresponding plurality of time frames, t₁, t₂, . . . , and tᵥ, produces a k-t sampling pattern of acquired data in k-t space, wherein k-space data is not acquired for some k-points in the k-t sampling pattern, wherein the k-points for which data is not acquired are considered missing data k-t points,
linearly interpolating the data for at least a portion of the missing data k-t points from the acquired data, wherein linearly interpolating the data for the missing data k-t points associated with one of the plurality of scans utilizes acquired data from at least one of the other scans of the plurality of scans, reconstructing an image from the one of the plurality of scans.

2. The method according to claim 1, wherein the k-space data acquired is acquired with respect to a polar coordinate system.

3. The method according to claim 1, wherein linearly interpolating the data for the missing data k-t points associated with one of the plurality of scans results in a full set of k-point data for the one of the plurality of scans;

4. The method according to claim 3, wherein reconstructing an image comprises applying a Fourier transform to the full set of k-point data for the one of the plurality of scans, wherein applying a Fourier transform generates an image associated with the one of the plurality of scans.

5. The method according to claim 1, wherein for each time frame, t₁, t₂, . . . , and tᵥ, the k-space data acquired during the corresponding time frame form a Cartesian grid in two dimensions of k-space, k_{y} and kₓ, where k_{y} is the phase encode direction and kₓ is the frequency encode direction,
wherein the Cartesian grid is centered at k_{y}=0, wherein the Cartesian grid expands on each side of k_{y}=0 on the k_{y}-axis, wherein the phase difference between adjacent k_{y}-points, Δk_{y}, are equally spaced such that
$$Δ {k}_{y} = \frac{π}{n} ,$$
where n is the index number of the highest indexed k_{y}-point on the k_{y}-axis.

6. The method according to claim 1, wherein the acquired data is time interleaved.

7. The method according to claim 1, wherein linearly interpolating the data for at least a portion of the missing data k-t points further utilizes acquired data from the one of the plurality of scans.

8. The method according to claim 5, wherein the k-t sampling pattern is based on a reduction factor, r, wherein the distance between two adjacent acquired data points along the k_{y} axis is rΔk_{y}.

9. The method according to claim 8, wherein the acquired data points along the k_{y} axis for a scan corresponding to time frame tₘ are k_{y}-shifted by n Δk_{y} for a successive scan corresponding time frame tₙ₊ₘ,

10. The method according to claim 1, wherein conducting a plurality of scans to acquire k-space data at discrete k-points on a k-space grid comprises acquiring for at least one value of k_{y} a k-space data for the at least one value of k_{y} for each of the plurality of scans so as to form a corresponding at least one auto-calibration signal (ACS) line.

11. The method according to claim 10, wherein the at least one value of k_{y} includes k_{y}=0.

12. The method according to claim 11, wherein a plurality of ACS lines are formed.

13. The method according to claim 5, wherein the k-space data is acquired from at least one individual coil,
wherein linearly interpolating the data for the missing data k-t points comprises a block wise reconstruction, such that
$${S}_{j}^{t} ( {k}_{y} - m Δ {k}_{y} ) = {\sum }_{l = 1}^{L} ( {\sum }_{b = 0}^{{N}_{b} - 1} {n}_{b} ( j , l , m ) {S}_{l}^{t} ( {k}_{y} - b r Δ {k}_{y} ) + {\sum }_{v = t - m , t + r - m} {n}^{v} ( j , l , m ) {S}_{l}^{v} ( {k}_{y} - m Δ {k}_{y} ) ) ,$$
wherein N_{b} is the number of blocks used in the reconstruction, where a block is defined as a single acquired line and r-1 missing lines,
wherein L is the number of channels corresponding to the number of individual coils,
wherein n_{b}(j,l,m) and n^{v}(j,l,m) are weights, where j is an individual coil index for other at least one individual coil, where m is the offset of a missing data k-t point from an acquired data point at line k_{y}, where the index l counts through the at least one individual coils, the index b counts through the individual reconstruction blocks, and the index v counts through the adjacent time frames that acquired data at line k_{y}-mΔk_{y}.

14. The method according to claim 13, wherein conducting a plurality of scans to acquire k-space data at discrete k-points on a k-space grid comprises acquiring for at least one value of k_{y} a k-space data for the at least one value of k_{y} for each of the plurality of scans so as to form a corresponding at least one auto-calibration signal (ACS) line, wherein the weights are produced by a linear fit of acquired data in the at least one ACS line.

15. The method according to claim 13, further comprising creating at least one auto-calibration signal (ACS) line for a corresponding at least one value of k_{y}, wherein creating the at least one ACS line comprises creating at least one ACS line from the acquired data.

16. The method according to claim 15, wherein the at least one ACS line is created by setting the value of the k-space position of each ACS line equal to the average of the acquired values for the k-space position of the ACS line.

17. The method according to claim 14, wherein linearly interpolating the data for the missing data k-t points comprises:
A) producing weights for interpolation, comprising:
i) selecting an acquired k_{y}-point from one of the ACS lines to represent a missing data k-t point at line k_{y}-mΔk_{y} in time t, where m is the offset of the missing data k-t point from an acquired k_{y}-point in the phase encode lines;
ii) linearly fitting the acquired data of a number of specifically chosen adjacent acquired data points from the same phase and/or the same time as the acquired data point; and
iii) repeating (i) and (ii) until all weight values are calculated from the linear fitting of the specifically chosen adjacent acquired data points corresponding to the arrangement of acquired data points from the phase-encode lines; and
B) reconstructing missing data for missing data k-points in the phase-encode lines by interpolating the missing data k-t points, wherein interpolating the missing data k-t points comprises:
i) selecting a missing data k-t point at line k_{y}-mΔk_{y} in time t, from the phase-encode lines;
ii) linearly fitting the acquired data of a number of adjacent acquired data from the same phase and/or the same time as the missing data k-t point;
iii) determining the missing data of the selected missing data k-t point from the linear fit of the adjacent acquired data points and the corresponding weight values for interpolation:

18. The method according to claim 17, wherein interpolating the missing data k-t points further comprises:
iv) repeating (i), (ii), and (iii) until all missing data from the phase-encoded lines are determined.

19. The method according to claim 17, wherein the specifically chosen adjacent acquired data points of (A)(ii) correspond to the arrangement of acquired data points from the phase-encode lines, such that the specifically chosen acquired data points correspond to line k_{y} in time t, line k_{y}-rΔk_{y} in time t, line k_{y}-mΔk_{y} in time t-m, and line k_{y}-mΔk_{y} in time t+r-m,
wherein the adjacent acquired data of (B)(ii) are data at line k_{y} in time t, data at line is k_{y}-rΔk_{y} in time t, data at line k_{y}-mΔk_{y} in time t-m, and data at line k_{y}-mΔk_{y} in time t+r-m.

20. The method according to claim 17, further comprising:
repeating (A) for each coil in a coil array, wherein each coil in the coil array is represented by a channel; wherein the number of specifically chosen adjacent acquired data points from the same phase and/or the same time as the acquired data point further comprise data points from each channel from the same phase and/or the same time as the acquired data point;
repeating (B) for each coil in the coil array wherein the number of adjacent acquired data points in the phase-encode lines from the same phase and/or the same time as the missing data k-t point further comprise data points from each channel from the same phase and/or the same time as the acquired data point:

21. The method according to claim 15, wherein the k-t sampling pattern provides the same arrangement of acquired data for each channel.

22. The method according to claim 20, further comprising:
reconstructing an image from the one of the plurality of scans for each coil in the coil array so as to generate an uncombined dynamic image series for each coil.

23. The method according to claim 22, further comprising, combining the uncombined dynamic images for each coil in the coil array, wherein combining the uncombined images comprises applying a normal sum-of-squares reconstruction.

24. The method according to claim 1, wherein reconstructing an image from the one of the plurality of scans comprises reconstructing a two-dimensional image.

25. The method according to claim 1, wherein reconstructing an image from the one of the plurality of scans comprises reconstructing a three-dimensional image.
